(19) United States
(12) Patent Application Publication
(10) Pub. No.: US 2024/0231303 A9
(43) Pub. Date: Jul. 11, 2024

(54) METHOD FOR OPERATING A PROCESSING APPARATUS AND CORRESPONDING PROCESSING APPARATUS

(71) Applicant: HOMAG GmbH, Schopfloch (DE)

(72) Inventors: Patrick SEEGER, Dornstetten-Hallwangen (DE); Ludwig ALBRECHT, Dornstetten-Aach (DE)

(21) Appl. No.: 18/277,721

(22) PCT Filed: Feb. 22, 2022
(86) PCT No.: PCT/EP2022/054367

§ 371 Date: Aug. 17, 2023

(30) Foreign Application Priority Data
Feb. 23, 2021 (DE) 10 2021 104 227.5

(51) Int. Cl. G05B 19/401; B05D 7/06

(52) U.S. Cl. CPC G05B 19/401; B05D 7/06; G05B 2219/37208; G05B 2219/45229

(57) ABSTRACT

The invention relates to a method for operating a processing apparatus and to a corresponding processing apparatus. Such a method and such an apparatus can be used in the field of furniture and components industry, for example for processing a plate-shaped workpiece made of wood, of a wood material, a wood-like material, of a composite material or a combination thereof.

### TECHNICAL FIELD

The invention relates to a method for operating a processing apparatus and to a corresponding processing apparatus. Such a method and such an apparatus can be used in the field of furniture and components industry, for example for processing a plate-shaped workpiece made of wood, of a wood material, a wood-like material, of a composite material or a combination thereof.

### PRIOR ART

In the field of furniture and components industry, it is increasingly observed that woodworking machines are operated by less qualified staff. However, in order to keep meeting the end customers' demands with regard to quality and delivery time, the requirements for the woodworking machines as such are increasing, in particular as to simplified operation and integrated quality control.

This requirement is opposed by the complexity of processing procedures in the field of woodworking. In particular, it has been shown that individual processing steps cause a wide variety of error patterns: For example, cracks or other defects in the coating material can occur during milling. Also, when applying coating material, the material may break, it may be applied at an angle on a narrow side, or the coating material may not adhere or not adhere sufficiently in sections. Individual errors, either individually or in combination, can lead to a negative quality rating.

To ensure high workpiece quality, operators are supported by guided menus and receive integrated supplementary information. After a processing procedure has been carried out, quality assessment is performed by “the trained eye” of the operator.

### DESCRIPTION OF THE INVENTION

The invention is based on the object of providing a method for operating a processing apparatus, with which manufacturing with the processing apparatus can be simplified and the quality of the processed workpieces can be maintained or even increased.

A corresponding method is defined in claim 1. Dependent claims relate to specific embodiments.

The invention has the advantage of considerably simplifying the operation of the processing apparatus, while providing increased quality control. Furthermore, process documentation can be carried out with regard to standards and process indicators. In addition, efficiency increases in the utilization of the production equipment and resource-saving machine operation are enabled. Early detection of quality defects reduces follow-up costs for the end customer.

The invention provides a method for operating a processing apparatus. The processing apparatus is configured in particular for processing a workpiece made of wood or wood materials, wood-like material, composite material or a combination thereof. The method comprises: transmitting at least one process parameter, preferably a plurality of process parameters, and at least one material parameter, preferably a plurality of material parameters, to a control unit of the processing apparatus, performing processing of a workpiece based on the at least one process parameter and the at least one material parameter, detecting the workpiece after processing with at least one sensor, assessing the workpiece by means of at least one criterion based on the values detected by the at least one sensor as well as the at least one process parameter and the at least one material parameter, and outputting the assessment of the workpiece. It is preferred that said steps are carried out in the corresponding order.

According to a further embodiment, it is provided that the process parameter or process parameters are selected from: a contact pressure of a pressure device, in particular a pressure roller, an adhesive temperature, a selection and/or combination of the processing units in use, a feed value of a processing unit and/or a feed rate of the workpiece. Thus, the method is in particular configured for a coating process, in the course of which a coating material is applied on a workpiece, in particular on a narrow surface/narrow side of a plate-shaped workpiece.

According to a further embodiment, it is provided that the material parameter or material parameters are selected from: a coating material, a workpiece material and/or a type of adhesive. Accordingly, the method is provided in particular for coating a workpiece.

Furthermore, it can be provided that the assessment of the workpiece is performed by means of a plurality of criteria, wherein it is preferred that the criteria are individually weighted and summarized to form an overall criterion. Thus, a quantification of the assessment can be performed.

It is preferred that the target values of the at least one process parameter and the at least one material parameter are used for calculating a probability of error after transmission to the control unit. This enables proactive process planning. In this regard, it can be assessed whether the deviation is not acceptable in terms of quality and a correction is therefore necessary for subsequent similar processing procedures. On this basis, the most probable cause for a specific error can be determined by means of data received and a result can be reported back to the control unit.

According to a further embodiment, it is provided that, if the assessment of the workpiece provides a negative result, one or a plurality of correction values are calculated for one or a plurality of process parameters.

In this regard, it can be provided that the correction value or correction values are suggested to an operator or that the process parameter or process parameters are changed.

If the correction value or the correction values are suggested to the operator, the operator has the option of considering the correction value or correction values when operating the machine, e.g. inputting the correction value or correction values, to thus modify or adjust the operation of the machine.

It is also possible to change one or a plurality of process parameters. Thus, a change can be made directly to change the operation of the machine. Accordingly, the automation of the operation of the machine can be further advanced with the option of reacting flexibly.

It is preferred that the assessment is performed using artificial intelligence. This enables further refinement of a quality model.

According to a preferred embodiment, the processing of the workpiece comprises applying and post-processing a coating material on a narrow surface of the workpiece, non-machining processing, for example additive processing, and/or processing by machining.

It is preferred that the sensor is an optical sensor, in particular a camera, or an acceleration sensor or a vibration sensor. In particular when combining a plurality of different sensors, a comprehensive assessment can be performed.

According to a further embodiment, it is provided that the assessment of the workpiece is performed by means of a computing unit of the control unit of the processing apparatus. Thus, an assessment of the workpiece can be performed locally/decentrally in the area of the processing apparatus.

The at least one process parameter and the at least one material parameter can be entered, for example by means of an operating panel or keyboard, or read in from a provided file. When the file is read in, there can be a direct effect on the operation of the machine, in particular while the machine is running.

It is preferred that the output of the assessment of the workpiece is performed by a visual display on an operation panel on the processing apparatus or by a visual display on a mobile unit, in particular a mobile phone. Thus, an operator can be promptly informed about the assessment result.

Additionally or alternatively, the output of the assessment is performed by an acoustic signal or tactile trigger, in particular by vibration of a mobile phone. Thus, it can be ensured that an operator is promptly and reliably informed.

### BRIEF DESCRIPTION OF THE DRAWING

FIG. 1 shows a schematic view for illustrating an embodiment of the invention.

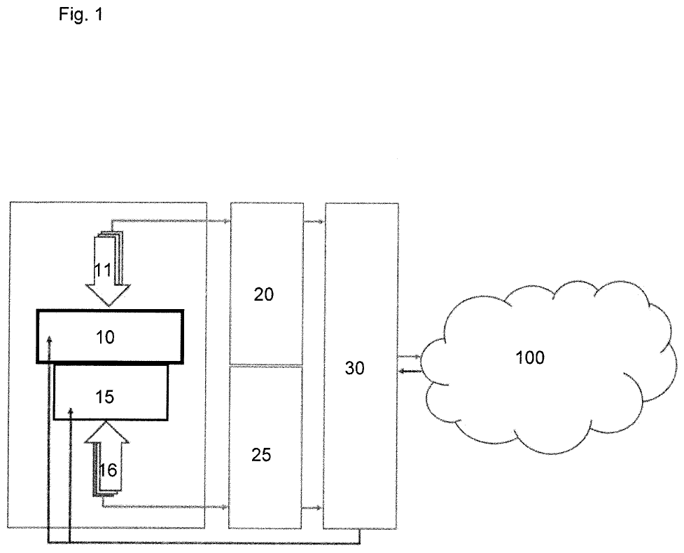

### DESCRIPTION OF THE EMBODIMENT

Within the scope of the embodiment described below, the focus is placed on a coating process as processing procedure, in the course of which coating process a coating material is applied on a narrow surface/narrow side of a plate-shaped workpiece. Such a coating material is applied on a workpiece in order to close the open-pored narrow surface or exposed core layer with the coating material, if the workpiece is a chipboard or lightweight board.

For processing plate-shaped workpieces, a first processing apparatus 10 configured for processing workpieces through pass as well as a second processing apparatus 15 configured as a so-called stationary machine are used. The first processing apparatus 10 and the second processing apparatus 15 are arranged in a factory building and, depending on the requirements, can apply a coating material in different manners on a narrow surface of a workpiece.

In the area of the first processing apparatus 10, first sensors 11 are provided, with which a respective workpiece already provided with a coating material can be detected. At the second processing apparatus 15, second sensors 16 are provided so that a respective workpiece can be detected in the area of the second processing apparatus 15. The second sensors 16 are arranged in such a way that a workpiece already provided with a coating material can be detected.

The first sensors 11 are connected with data processing means 20 which is configured for processing data received from the sensors 11 and transmitting said data to a control unit 30. The control unit 30 is provided separately from the first processing apparatus 10. However, the control unit 30 can also be arranged at the first processing apparatus 10.

The control unit can be connected with a cloud-based platform 100 which can support the control unit 30 when performing the operations described below. In particular, information centrally stored by the platform 100 can be provided to the control unit 30. Information from a processing procedure of the processing apparatus 10 can also be stored in the platform 100.

Accordingly, the second sensors 16 are connected with a data processing means 25, wherein said data processing means 25 is configured for processing the data received by the second sensors 16 and transmitting said data to a control unit 30.

The control unit 30 comprises a computing unit with which a workpiece detected by the sensors 11 or 16 can be assessed. For this purpose, the control unit 30 comprises an assessment algorithm. If the assessment of the workpiece provides a negative result, the control unit 30 transmits one or a plurality of correction values for one or a plurality of process parameters to the respective processing apparatus 10, 15. In this regard, it can be provided that the correction value or correction values are suggested to an operator who can subsequently change one or a plurality of process parameters, or the process parameter or process parameters can be directly changed by the feedback of the control unit 30, for example while the machine is running.

The number of processing apparatuses 10, 15 described within the scope of the embodiment example is not limited to the described number. Rather, one processing apparatus or also more than two processing apparatuses can be provided.

The control unit 30 is provided in the embodiment example separately from the first processing apparatus 10 and the second processing apparatus 20. However, the control unit 30 can also be arranged at one of the processing apparatuses, in particular if a processing apparatus is provided.

A process sequence is described below by means of a processing procedure, in the course of which a workpiece is provided with a coating material.

A high-quality processing result is achieved if the coating material covers the entire narrow surface and a gap-free adhesion of the coating material is provided. The classification of the processing result is based on quality criteria which are, for example, composed of factory guidelines and standards/norms of the woodworking industry. Assessment of a workpiece is performed by means of at least one quality criterion based on the values detected by the at least one sensor 11, 16 as well as the process parameters and the at least one material parameter. In this regard, quality criteria can be qualitative pull-off forces for separating the coating material from the workpiece, a milling edge chipping and edge course/geometry defects. To provide an overall criterion, the quality criteria are respectively weighted and combined with each other.

For processing a workpiece, firstly at least one, preferably a plurality of, process parameters of the processing apparatus 10 or 15 is set. In a coating process, this relates to the contact pressure or the infeed depth of a pressure roller, the adhesive temperature of the adhesive to be applied on the workpiece and/or the coating material, the selection and/or combination of the processing units in use, the feed value of a respective processing unit and/or the feed rate of the workpiece.

Furthermore, the operator of the processing apparatus 10 or 15 selects a plurality of material parameters to render the processing procedure more precise. In particular, the operator selects a coating material, a workpiece material and a type of adhesive.

The at least one process parameter and the at least one material parameter are supplied to the control unit 30. In this regard, the parameters are target values.

Prior to the actual processing procedure, the control unit 30 can calculate a probability of error, i.e. a probability with which a workpiece to be manufactured meets the quality criteria. In the course of calculation, causes for errors can also be calculated and suggestions on how to remedy said errors can be displayed to the operator of the processing apparatus 10 or 15. Such displaying can be provided on a monitor in the area of the respective processing apparatus 10, 15 or on a mobile device, such as a mobile phone.

If the operator supplies the at least one process parameter to the processing apparatus 10 or 15 and starts operation thereof, the workpiece is manufactured with the transmitted process parameter or process parameters and the material parameter or material parameters.

After conclusion of the manufacturing of the workpiece, an assessment of the workpiece is performed by means of the respective sensors 11 or 16. In particular, an optical sensor is used in this regard which detects a course of the coating material and/or a geometry defect of the coating material applied on the workpiece. If a so-called edge course defect is detected, the optical sensor recognizes that the coating material adheres without gaps to the workpiece, but does not cover the entire narrow surface of the workpiece. By means of the values detected by the sensor, an obliquely extending coating material can thus be detected quantitatively. The specification is made by indicating a specific angle which determines the course of the coating material relative to an ideal straight course.

The data acquired by the first sensors 11 are transmitted to a first data processing unit 20 and the data acquired by the second sensors 16 are transmitted to a second data processing unit 25, which process the information and transmit it to the control unit 30.

The control unit 30 assesses the extent of the detected defect and, if it exceeds a maximum tolerable range, assesses that the deviation is qualitatively unacceptable and, therefore, a correction will be required for subsequent similar processing procedures. In the course of this, the most probable cause for the error can also be determined and the result can be transmitted to the machine controller.

An error message is displayed to the operator of the processing apparatus 10 or 15, stating that the workpiece just produced does not meet the manufacturing quality requirements. In this regard, a corrected process parameter or, if applicable, a plurality of process parameters to be corrected are suggested to the operator of the machine, for example a reduction of the contact pressure of the pressure roller. The operator can adopt the suggested change for further processing procedures, so that the changed process parameter or process parameters are transmitted to the controller. In the course of this, the operator of the processing apparatus is requested to confirm the suggested, corrected process parameters. In the event of automated manufacturing, the corrected process parameters can be directly transmitted to the controller.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. Method for operating a processing apparatus, the method comprising:
transmitting at least one process parameter and at least one material parameter to a control unit of the processing apparatus;
performing processing of a workpiece based on the at least one process parameter and the at least one material parameter;
detecting values of the workpiece, after the performing processing, with at least one sensor;
assessing the workpiece by means of at least one criterion based on the values detected by the at least one sensor as well as the at least one process parameter and the at least one material parameter; and
outputting the assessment of the workpiece.

2. Method according to claim 1, in which the at least one process parameter is selected from: a contact pressure of a pressure device, an adhesive temperature, a selection, processing units in use, a feed value of a processing unit, or a feed rate of the workpiece.

3. Method according to claim 1, in which the at least one material parameter is selected from: a coating material, a workpiece material, or a type of adhesive.

4. Method according to claim 1, in which the assessment of the workpiece is performed by means of a plurality of criteria, wherein the plurality of criteria are individually weighted and summarized to form an overall criterion.

5. Method according to claim 1, in which a target value of the at least one process parameter and the at least one material parameter are used for calculating a probability of error after transmission to the control unit.

6. Method according to claim 1, in which, if the assessment of the workpiece provides a negative result, at least one correction value is calculated for one or a plurality of process parameters.

7. Method according to claim 1, in which the assessment is performed using artificial intelligence.

8. Method according to claim 1, in which the processing of the workpiece comprises applying and post-processing a coating material on a narrow surface of the workpiece.

9. Method according to claim 1, in which the sensor is an optical sensor, an acceleration sensor or a vibration sensor.

10. Method according to claim 1, in which the assessment of the workpiece is performed by means of a computing unit of the control unit of the processing apparatus.

11. Method according to claim 1, in which the at least one process parameter and the at least one material parameter are entered or read in.

12. Method according to claim 1, in which the output of the assessment of the workpiece is performed by a visual display on an operation panel on the processing apparatus or by a visual display on a mobile unit.

13. Method according to claim 1, in which the output of the assessment is performed by an acoustic signal or tactile trigger.

14. Method according to claim 1, wherein the processing apparatus is configured for processing a workpiece made of wood or wood materials, wood-like material, composite material or a combination thereof.

15. Method according to claim 6, wherein the correction value or correction values are suggested to an operator or that the process parameter or process parameters are changed.

16. Method according to claim 12, wherein the mobile unit comprises a mobile phone, and the output is performed by vibration of the mobile phone.
